(19) United States
(12) Patent Application Publication
(10) Pub. No.: US 2020/0329394 A1
(43) Pub. Date: Oct. 15, 2020

(54) METHOD AND DEVICE FOR CONFIGURING MDT, AND METHOD AND DEVICE FOR MDT MEASUREMENT

(71) Applicant: VIVO MOBILE COMMUNICATION CO., LTD., Guangdong (CN)

(72) Inventors: Boubacar KIMBA DIT ADAMOU, Guangdong (CN); Xiaodong YANG, Guangdong (CN)

(21) Appl. No.: 16/759,390

(22) PCT Filed: Nov. 22, 2018
(86) PCT No.: PCT/CN2018/116912

§ 371 Date: Apr. 27, 2020

(30) Foreign Application Priority Data
Nov. 22, 2017 (CN) 201711175852.4

(51) Int. Cl. H04W 24/10; H04W 24/08

(52) U.S. Cl. CPC H04W 24/10; H04W 24/08

(57) ABSTRACT

A method and a device for configuring MDT, a method and a device for MDT measurement are provided. The method of configuring the MDT is applied to a base station of a first network, and includes: receiving information on whether a UE supports execution of MDT measurement of a second network; receiving information about configuration of the MDT measurement of the second network transmitted by a network manager; selecting, based on the information about the configuration of the MDT measurement and the information on whether the UE supports the execution of the MDT measurement of the second network, a UE for executing the MDT measurement of the second network; and transmitting, to the selected UE, information about configuration for activating the UE to execute the MDT measurement of the second network.

### CROSS-REFERENCE TO RELATED APPLICATIONS

The present application claims a priority to Chinese patent application No. 201711175852.4 filed in China on Nov. 22, 2017, the disclosure of which is incorporated herein by reference in its entirety.

### TECHNICAL FIELD

The present disclosure relates to the field of wireless communication technologies, and in particular, to a method and a device for configuring Minimization of Drive-Test (MDT), a method and a device for MDT measurement.

### BACKGROUND

In network optimization of a mobile communication system in related art, a drive-test method is usually used to check a network coverage quality and determine whether a system performance meets expected design requirements. That is, a professional network optimization person drives a measurement vehicle to move randomly, and a measurement terminal records events and measurement data during the movement, which are provided to the operators for being used in making network optimization decisions. As such, the drive-test operation is performed manually, which requires a lot of manpower and consumes excessive time, and puts huge burdens on the network construction made by the operators and causes high maintenance costs. On the other hand, the drive-test operation generally has to be performed outdoors, and cannot be implemented with respect to indoor environment or a particular private area. Therefore, the drive-test operation is hard to be used in the network optimization at these locations.

In a 4-th Generation (4G) Long Term Evolution (LTE) system, an evolved LTE (eLTE) system, and a 5-th Generation (5G) New Radio (NR) system, a study on the MDT is proposed. The MDT is a technology in which the communication system enables to automatically acquire and analyze a measurement report of a User Equipment (UE) containing location information, and is used for reducing the workload of the manual drive-test operation as much as possible.

The 5G NR system, in its early stage of the development, will coexist with the 4G LTE/eLTE system for a long time. Therefore, there is a need to solve the technical problem on how to configure MDT and execute MDT measurement in a heterogeneous network.

### SUMMARY

In a first aspect, an embodiment of the present disclosure provides a method for configuring Minimization of MDT, which is applied to a base station of a first network. The method includes: storing information on whether a UE supports execution of MDT measurement of a second network; receiving information about configuration of the MDT measurement of the second network transmitted by a network manager; selecting, based on the information about the configuration of the MDT measurement and the stored information on whether the UE supports the execution of the MDT measurement of the second network, a UE for executing the MDT measurement of the second network; and transmitting, to the selected UE, information about configuration for activating the UE to execute the MDT measurement of the second network.

In a second aspect, an embodiment of the present disclosure provides a method for MDT measurement, which is applied to a UE. The method includes: receiving, from a base station of a first network, information about configuration for activating the UE to execute MDT measurement of a second network; executing the MDT measurement of the second network based on the information about the configuration for activating the UE to execute the MDT measurement of the second network, to obtain data of the MDT measurement of the second network; and reporting the data of the MDT measurement of the second network.

In a third aspect, an embodiment of the present disclosure provide a base station, which is located in a first network. The base station includes: a storing module, configured to store information on whether a UE supports execution of MDT measurement of a second network; a first receiving module, configured to receive information about configuration of the MDT measurement of the second network transmitted by a network manager; a selecting module, configured to select, based on the information about the configuration of the MDT measurement and the stored information on whether the UE supports the execution of the MDT measurement of the second network, a UE for executing the MDT measurement of the second network; and a first transmitting module, configured to transmit, to the selected UE, information about configuration for activating the UE to execute the MDT measurement of the second network.

In a fourth aspect, an embodiment of the present disclosure provide a UE. The UE includes: a receiving module, configured to receive, from a base station of a first network, information about configuration for activating the UE to execute MDT measurement of a second network; an MDT measurement module, configured to execute the MDT measurement of the second network based on the information about the configuration for activating the UE to execute the MDT measurement of the second network, to obtain data of the MDT measurement of the second network; and a reporting module, configured to report the data of the MDT measurement of the second network.

In a fifth aspect, an embodiment of the present disclosure provide a base station, including: a memory, a processor, and a program stored in the memory and capable of being executed by the processor, wherein the processor is configured to execute the program to implement steps of the method for configuring the MDT as described in the above first aspect.

In a sixth aspect, an embodiment of the present disclosure provide a UE, including: a memory, a processor, and a program stored in the memory and capable of being executed by the processor, wherein the processor is configured to execute the program to implement steps of the method for the MDT measurement as described in the above second aspect.

In a seventh aspect, an embodiment of the present disclosure provides a computer-readable storage medium storing therein a program, wherein the program is executed by a processor, to implement steps of the method for configuring the MDT as described in the above first aspect.

In an eighth aspect, an embodiment of the present disclosure provides a computer-readable storage medium storing therein a program, wherein the program is executed by a processor, to implement steps of the method for the MDT measurement as described in the above second aspect.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a schematic flow chart showing a method for configuring MDT according to an embodiment of the present disclosure;

FIG. 2 is a schematic flow chart showing the method for MDT measurement according to an embodiment of the present disclosure;

FIG. 3 is a schematic structural diagram of a base station according to an embodiment of the present disclosure;

FIG. 4 is a schematic structural diagram of a UE according to an embodiment of the present disclosure;

FIG. 5 is a schematic structural diagram of another base station according to an embodiment of the present disclosure;

FIG. 6 is a schematic structural diagram of another UE according to an embodiment of the present disclosure; and

FIG. 7 is a schematic structural diagram of yet another UE according to an embodiment of the present disclosure.

### DETAILED DESCRIPTION

In order to more clearly illustrate objects, technical solutions and advantages of embodiments of the present disclosure, the technical solutions in the embodiments of the present disclosure will be clearly and completely described below in combination with the accompanying drawings in the embodiments of the present disclosure. Obviously, the following embodiments merely relate to a part of, rather than all of, the embodiments of the present disclosure. Based on these embodiments of the present disclosure described herein, a person skilled in the art may, without any creative effort, obtain the other embodiments, which also fall within the scope of the present disclosure.

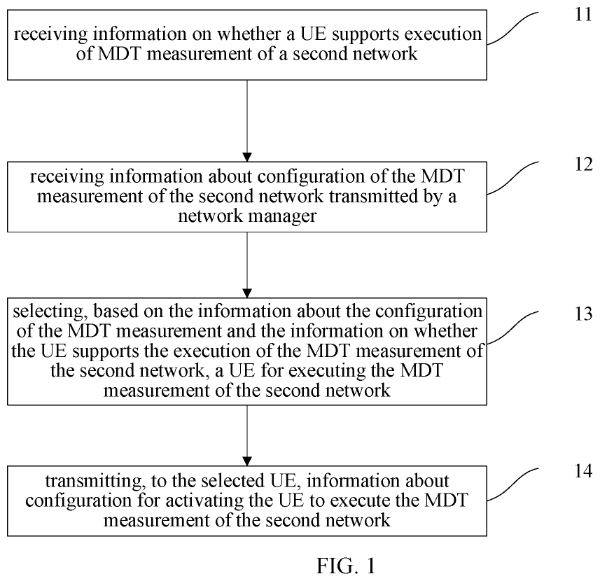

Referring to FIG. 1, an embodiment of the present disclosure provides a method for configuring MDT, which is applied to a base station of a first network. The method includes following steps.

Step 11: storing information on whether a UE supports execution of MDT measurement of a second network.

Step 12: receiving information about configuration of the MDT measurement of the second network transmitted by a network manager.

Step 13: selecting, based on the information about the configuration of the MDT measurement and the stored information on whether the UE supports the execution of the MDT measurement of the second network, a UE for executing the MDT measurement of the second network; and

Step 14: transmitting, to the selected UE, information about configuration for activating the UE to execute the MDT measurement of the second network.

According to an embodiment of the present disclosure, the base station of the first network is configured to store the information on whether the UE supports the execution of the MDT measurement of the second network, receive the information about the configuration of the MDT measurement of the second network transmitted by the network manager, select a UE for executing the MDT measurement of the second network, and transmit, to the selected UE, the information about configuration for activating the UE to execute the MDT measurement of the second network. In this way, the base station of the first network can control as well the UE to execute the configuration of the MDT measurement of the second network, so that the configuration of the MDT measurement and the MDT measurement may be implemented in the heterogeneous network, thereby improving the compatibility of the MDT measurement in the heterogeneous network.

In an embodiment of the present disclosure, the first network may be a LTE network or an eLTE network and the second network may be a 5G NR network; or, the first network is a 5G NR network and the second network is a LTE network or an eLTE network.

In an embodiment of the present disclosure, the UE which may support the execution of the MDT measurement of the second network needs to meet the following conditions: the UE agrees to execute the MDT measurement of the second network, and the UE has the capability of executing the MDT measurement of the second network.

In some embodiments of the present disclosure, the information about the configuration for activating the UE to execute the MDT measurement of the second network may include: information for configuring the MDT measurement and indication information for activating the MDT measurement. In this case, the information for configuring the MDT measurement is used to configure a parameter about the MDT measurement of the second network of the UE, and the indication information for activating the MDT measurement is used to activate the UE to execute the MDT measurement of the second network. The UE, which receives the information for configuring the MDT measurement and the indication information for activating the MDT measurement, will execute the MDT measurement of the second network according to content of the information for configuring the MDT measurement.

In further embodiments of the present disclosure, the information about the configuration for activating the UE to execute the MDT measurement of the second network may include only information for configuring the MDT measurement. In this case, the information for configuring the MDT measurement is used to configure a parameter about the MDT measurement of the second network of the UE, and to activate the UE to execute the MDT measurement of the second network. The UE, which receives the information for configuring the MDT measurement, will execute the MDT measurement of the second network according to content of the information for configuring the MDT measurement.

When the information about the configuration for activating the UE to execute the MDT measurement of the second network includes the information for configuring the MDT measurement and the indication information for activating the MDT measurement, the step of transmitting, to the selected UE, the information about the configuration for activating the UE to execute the MDT measurement of the second network may include: transmitting, to the selected UE, the information about the configuration for activating the UE to execute the MDT measurement of the second network through only one piece of signaling; or transmitting, to the selected UE, the information about the configuration for activating the UE to execute the MDT measurement of the second network through two pieces of signaling.

In other words, the base station of the first network can transmit simultaneously, when the MDT measurement needs to be executed, the information for configuring the MDT measurement and the indication information for activating the MDT measurement to the UE through only one piece of signaling; alternatively, the base station of the first network can firstly transmit the information for configuring the MDT measurement to the UE through one piece of signaling, and then transmit the indication information for activating the MDT measurement to the UE through another piece of signaling when the MDT measurement of the second network needs to be executed.

In some embodiments of the present disclosure, the information about the configuration of the MDT measurement of the second network may include: MDT tracking report information and indication information for activating the MDT tracking report information. In this case, the MDT tracking report information is used to configure a parameter about the MDT measurement of an object for executing the MDT, and the indication information for activating the MDT tracking report information is used to activate the object for executing the MDT to execute MDT measurement. The object for executing the MDT is a base station and/or a UE.

In further embodiments of the present disclosure, the information about the configuration of the MDT measurement of the second network may include only MDT tracking report information. In this case, the MDT tracking report information is used to configure a parameter about the MDT measurement of an object for executing the MDT, and to activate the object for executing the MDT to execute MDT measurement. The object for executing the MDT is a base station and/or a UE.

In some embodiments of the present disclosure, when the information about the configuration of the MDT measurement of the second network includes the MDT tracking report information and the indication information for activating the MDT tracking report information, the step of receiving the information about the configuration of the MDT measurement of the second network transmitted by the network manager includes: receiving the MDT tracking report information and the indication information for activating the MDT tracking report information both transmitted simultaneously by the network manager through one piece of signaling.

In other words, the network manager can transmit, when the MDT measurement needs to be activated, the MDT tracking report information and the indication information for activating the MDT tracking report information to the base station of the first network at the same time.

It should be appreciated that, in some other embodiments of the present disclosure, the step of receiving the information about the configuration of the MDT measurement of the second network transmitted by the network manager includes: receiving the MDT tracking report information and the indication information for activating the MDT tracking report information transmitted separately by the network manager through respective two pieces of signaling.

In other words, the network manager can firstly transmit the MDT tracking report information to the base station of the first network through one piece of signaling, and then transmit, when the MDT measurement needs to be activated, the indication information for activating the MDT tracking report information to the base station of the first network through another piece of signaling.

In an embodiment of the present disclosure, it includes: transmitting to the selected UE the information about the configuration for activating the UE to execute the MDT measurement of the second network, when the selected UE is in a non-idle state; the non-idle state includes a Radio Resource Control (RRC) connection state, a RRC inactive state, an RRC-recovery-request initiating state, a service-request initiating state, an access-notification-area-update initiating state, and a tracking-area-update initiating state.

In other words, only when the selected UE for executing the MDT measurement of the second network is in a non-idle state, the information about the configuration for activating the UE to execute the MDT measurement of the second network is transmitted to the UE. When the selected UE for executing the MDT measurement of the second network is in an idle state, the information about the configuration for activating the UE to execute the MDT measurement of the second network is not transmitted to the UE.

In an embodiment of the present disclosure, the method further includes: before the step of storing, by the base station of the first network, the information on whether the UE supports the execution of the MDT measurement of the second network: receiving the information on whether the UE supports the execution of the MDT measurement of the second network, wherein the information on whether the UE supports the execution of the MDT measurement of the second network is transmitted by a network node of the first network; or receiving the information on whether the UE supports the execution of the MDT measurement of the second network, wherein the information on whether the UE supports the execution of the MDT measurement of the second network is transmitted by a base station of the second network; or receiving the information on whether the UE supports the execution of the MDT measurement of the second network, wherein the information on whether the UE supports the execution of the MDT measurement of the second network is transmitted by a network node of the second network; or receiving the information on whether the UE supports the execution of the MDT measurement of the second network, wherein the information on whether the UE supports the execution of the MDT measurement of the second network is forwarded by a network node of the second network through a base station of the second network.

In an embodiment of the present disclosure, the first network may be a LTE network or an eLTE network and the second network may be a 5G NR network; alternatively, the first network may be a 5G NR network and the second network may be a LTE network or an eLTE network.

A network node of the 5G NR network may be a User Data Management (UDM), a Session Management Function (SMF) or an Access and Mobility Management Function (AMF).

A network node of the LTE network or the eLTE network may be a Home Subscriber Server (HSS), or a Mobility Management Entity (MME).

In an embodiment of the present disclosure, optionally, the information on whether the UE supports the execution of the MDT measurement of the second network is included in UE context information or UE initial context establishing request information.

In an embodiment of the present disclosure, optionally, the method further includes: after the step of storing, by the base station of the first network, the information on whether the UE supports the execution of the MDT measurement of the second network: transmitting, by the base station of the first network, when the UE is being handed over from the base station of the first network to a target base station, information on whether the UE supports the execution of the MDT measurement of the second network which corresponds to the UE being handed over, to the target base station. In this way, the MDT measurement can be executed no matter on whichever the base station the UE is being handed over to.

In the embodiment of the present disclosure, optionally, the step of selecting, based on the information about the configuration of the MDT measurement and the stored information on whether the UE supports the execution of the MDT measurement of the second network, the UE for executing the MDT measurement of the second network includes: determining, based on the information about the configuration of the MDT measurement of the second network, whether the UE is in an area specified by the information about the configuration of the MDT measurement of the second network, and determining, based on the stored information on whether the UE supports the execution of the MDT measurement of the second network, whether the UE supports the execution of the MDT measurement of the second network; selecting, when the UE is located in the area specified by the information about the configuration of the MDT measurement of the second network and supports the execution of the MDT measurement of the second network, the UE to execute the MDT measurement of the second network; and not selecting, when the UE is not located in the area specified by the information about the configuration of the MDT measurement of the second network or does not support the execution of the MDT measurement of the second network, the UE to execute the MDT measurement of the second network.

In some embodiments of the present disclosure, the base station of the first network and the base station of the second network may share the network manager, and the step of receiving the information about the configuration of the MDT measurement of the second network transmitted by the network manager includes: receiving the information about the configuration of the MDT measurement of the second network directly transmitted by the network manager; or receiving the information about the configuration of the MDT measurement of the second network forwarded by the network manager through the network node of the first network.

In some further embodiments of the present disclosure, the base station of the first network and the base station of the second network correspond to respective independent network managers, and the step of receiving the information about the configuration of the MDT measurement of the second network transmitted by the network manager includes: receiving the information about the configuration of the MDT measurement of the second network forwarded by the network manager of the second network through the network manager of the first network, wherein the network manager of the first network receives the information about the configuration of the MDT measurement of the second network, and directly forwards the received information about the configuration of the MDT measurement of the second network to the base station of the first network; or the network manager of the first network receives the information about the configuration of the MDT measurement of the second network, and forwards the received information about the configuration of the MDT measurement of the second network to the base station of the first network through the network node of the first network; or receiving the information about the configuration of the MDT measurement of the second network forwarded by the network manager of the second network through the base station of the second network, wherein the network manager of the second network directly transmits the information about the configuration of the MDT measurement of the second network to the base station of the second network, and the base station of the second network forwards the information about the configuration of the MDT measurement of the second network to the base station of the first network; or the network manager of the second network transmits the information about the configuration of the MDT measurement of the second network to the network node of the second network, the network node of the second network forwards the information about the configuration of the MDT measurement of the second network to the base station of the second network, and the base station of the second network forwards the information about the configuration of the MDT measurement of the second network to the base station of the first network.

In an embodiment of the present disclosure, the step of transmitting to the selected UE the information about the configuration for activating the UE to execute the MDT measurement of the second network includes: transmitting to the selected UE the information about the configuration for activating the UE to execute the MDT measurement of the second network through any one or more of an RRC reconfiguration message, an RRC recovery message, an RRC suspending message, an RRC releasing message and an RRC connection establishment message.

The method for configuring the MDT according to the embodiments of the present disclosure will be described below in conjunction with specific application scenarios.

In a first embodiment, a base station of an LTE or eLTE network (a first network) is used to configure MDT measurement of a NR network (a second network).

Step 21: the base station of the LTE or eLTE network receives and stores information on whether a UE supports execution of the MDT measurement of the NR network.

In an embodiment of the present disclosure, when the UE initially accesses, if the UE supports the execution of the MDT measurement of the NR network, the information on whether the UE supports the execution of the MDT measurement of the NR network is transmitted to the base station of the LTE or eLTE network by using the following method in which: the network node HSS or MME directly transmits the information that the UE supports the execution of the MDT measurement of the NR network to the base station of the LTE or eLTE network; or the HSS transmits the information that the UE supports the execution of the MDT measurement of the NR network to the MME, and then the MME forwards the information to the base station of the LTE or eLTE network; or the MME transmits the information that the UE supports the execution of the MDT measurement of the NR network to the base station of the LTE or eLTE network; or the base station of the NR network transmits the information that the UE supports the execution of the MDT measurement of the NR network to the base station of the LTE or eLTE network; or the network node UDM or SMF or AMF directly transmits the information that the UE supports the execution of the MDT measurement of the NR network to the base station of the NR network, and then the base station of the NR network forwards the information to the base station of the LTE or eLTE network; or the UDM transmits the information that the UE supports the execution of the MDT measurement of the NR network to the SMF, and then the SMF forwards the information to the AMF, and then the AMF forwards the information to the base station of the NR network, and then the base station of the NR network forwards the information to the base station of the LTE or eLTE network; or the SMF transmits the information that the UE supports the execution of the MDT measurement of the NR network to the AMF, and then the AMF forwards the information to the base station of the NR network, and then the base station of the NR network forwards the information to the base station of the LTE or eLTE network; or the network node UDM or SMF or AM directly transmits the information that the UE supports the execution of the MDT measurement of the NR network to the base station of the LTE or eLTE network; or the UDM transmits the information that the UE supports the execution of the MDT measurement of the NR network to the SMF, and then the SMF forwards the information to the AMF, and then the AMF forwards the information to the base station of the LTE or eLTE network; or the SMF transmits the information that the UE supports the execution of the MDT measurement of the NR network to the AMF, and then the AMF forwards the information to the base station of the LTE or eLTE network.

In an embodiment of the present disclosure, the information that the UE supports the execution of the MDT measurement of the NR network is included in UE context information or UE initial context establishing request information.

In an embodiment of the present disclosure, when the base station of the LTE or eLTE network receives the information that the UE supports the execution of the MDT measurement of the NR network, the base station will store the information that the UE supports the execution of the MDT measurement of the NR network. When the UE is being handed over from the base station of the LTE or eLTE network to a target base station, the information on whether the UE supports the execution of the MDT measurement of the NR network which corresponds to the UE being handed over is transmitted by the base station of the LTE or eLTE network to the target base station. In this way, the MDT measurement can be executed no matter on whichever the base station the UE is handed over to. The information on whether the UE supports the execution of the MDT measurement of the NR network may be included in handover request information or other signaling. Once receiving the information on whether the UE supports the execution of the MDT measurement of the NR network, the target base station will store the information on whether the UE supports the execution of the MDT measurement of the NR network.

Step 22: the base station of the LTE or eLTE network receives the MDT tracking report information of the NR network transmitted by the network manager.

The MDT tracking report information of the NR network may include at least one of the following parameters.

1). A MDT measurement type, wherein the MDT measurement type includes: a logged MDT or an immediate MDT.

2). A MDT measurement area parameter, that is, a parameter indicating which regions need to activate the MDT measurement, wherein the MDT measurement area parameter may include a network slice list, an Radio Access Network (RAN) paging area, an RAN notification area, an RAN location area, a system information area, a Core Network (CN) tracking area, or network cell information such as a cell Physical Cell Identifier (PCI).

3). A measurement list, wherein the measurement list may include:

31). a UE measurement list, wherein the UE measurement list may include at least one of the following parameters:
a Power Headroom (PH);
a Reference Signal Receiving Power (RSRP)/Reference Signal Receiving Quality (RSRQ)/Signal to Interference Plus Noise Ratio (SINR) of an Synchronization Signal (SS) block, a Primary Synchronization Signal (PSS) and a Secondary Synchronization Signal (SSS) of the SS block, and a related Physical Broadcast Channel (PBCH);
measurement of the PSS and the SSS, which may include beam time index;
measurement of the PBCH, which may include measurement of a Demodulation Reference Signal (DMRS) and related beam information;
measurement of the RSRP/RSRQ/SINR of a Channel State Information-Reference Signal (CSI-RS);
measurement information of a Tracking Reference Signal (TRS)/a Phase-Tracking Reference Signal (PTRS);

32). a base station measurement list, wherein the base station measurement list may include at least one of the following parameters:
a Received Interference Power (RIP) measurement;
a Data Volume (DV) measurement, including a Down Link (DL) and/or an Up Link (UL);
a Scheduled IP (Internet Protocol) Throughput (SIT).

4). A condition for reporting the MDT measurement, including the reporting by the UE and/or the base station.

5). An MDT measurement reporting interval.

6). A value of reported MDT measurement.

7). An event threshold, such as an RSRP threshold and/or an RSRQ threshold.

8). An MDT measurement recording interval.

9). An MDT measurement recording duration.

10). A trace reference.

11). An MDT Trace Collection Element (TCE) IP address.

12). An MDT data anonymization.

13). A measurement period, such as a DV and/or SIT measurement period.

14). A Radio Resource Management (RRM) measurement period, such as a PH measurement and/or RIP measurement period.

15). A positioning method, including a Global Positioning System (GPS), an Observed Time Difference of Arrival (OTDOA) and the like.

16). An MDT Public Land Mobile Network (PLMN) list.

In an embodiment of the present disclosure, the base station of the LTE or eLTE network is configured to determine, based on the information about the configuration of the MDT measurement of the NR network, whether the UE is in an area specified by the information about the configuration of the MDT measurement of the NR network; and determine, based on the stored information on whether the UE supports the execution of the MDT measurement of the NR network, whether the UE supports the execution of the MDT measurement of the NR network; select, when the UE is located in the area specified by the information about the configuration of the MDT measurement of the NR network and supports the execution of the MDT measurement of the NR network, the UE to execute the MDT measurement of the NR network; and not select, when the UE is not located in the area specified by the information about the configuration of the MDT measurement of the NR network or does not support the execution of the MDT measurement of the NR network, the UE to execute the MDT measurement of the NR network.

In an embodiment of the present disclosure, the base station of the LTE or eLTE network and the base station of the NR network may share the network manager. In this case, the step of receiving, by the base station of the LTE or eLTE network, the MDT tracking report information of the NR network transmitted by the network manager may include steps in which: the network manager directly transmits the MDT tracking report information to the base station of the LTE or eLTE network; or the network manager transmits the MDT tracking report information to the HSS, and then the HSS forwards the information to the base station of the LTE or eLTE network; or the network manager transmits the MDT tracking report information to the HSS, and then the HSS forwards the information to the MME, and then the MME forwards the information to the base station of the LTE or eLTE network.

In an embodiment of the present disclosure, the base station of the LTE or eLTE network and the base station of the NR network may correspond to respective independent network managers. In this case, the step of receiving, by the base station of the LTE or eLTE network, the MDT tracking report information of the NR network transmitted by the network manager may include: the network manager of the NR network transmits the MDT tracking report information to the network manager of the LTE or eLTE network, and then the network manager of the LTE or eLTE network transmits the information to the base station of the LTE or eLTE network; or the network manager of the LTE or eLTE network transmits the MDT tracking report information to the HSS, and then the HSS forwards the information to the base station of the eLTE network; or the network manager of the LTE or eLTE network transmits the MDT tracking report information to the HSS, and then the HSS forwards the information to the MME, and then the MME forwards the information to the base station of the LTE or eLTE network.

Step 23: the base station of the LTE or eLTE network is configured to select, based on the MDT tracking report information and the stored information on whether UE supports the execution of the MDT measurement of the NR network, the UE to execute the MDT measurement of the NR network; transmit, to the selected UE, the information about the configuration for activating the UE to execute the MDT measurement of the NR network.

In an embodiment of the present disclosure, the base station of the LTE or eLTE network may transmit, to the selected UE, the information about the configuration for activating the UE to execute the MDT measurement of the second network through any one or more of an RRC reconfiguration message, an RRC recovery message, an RRC suspending message, an RRC releasing message and an RRC connection establishment message.

In an embodiment of the present disclosure, when the UE receives, from the base station of the LTE or eLTE network, the information about the configuration for activating the UE to execute the MDT measurement of the NR network, the UE may execute the MDT measurement of the NR network based on the information about the configuration for activating the UE to execute the MDT measurement of the NR network, record the data of the MDT measurement, and report the data to the network.

The information about the configuration for activating the UE to execute the MDT measurement of the NR network includes a type of the MDT measurement, wherein the type of the MDT measurement is a logged MDT or an immediate MDT. When the type of the MDT measurement is the immediate MDT, the step of reporting, by the UE, the data of the MDT measurement of the NR network includes: reporting the data of the MDT measurement of the NR network to the base station of the LTE or eLTE network or the base station of the NR network, when the UE is in an RRC connection state or a RRC inactive state. When the type of the MDT measurement is the logged MDT, the step of reporting, by the UE, the data of the MDT measurement of the NR network includes: transmitting, by the UE to the base station of the LTE or eLTE network and/or the base station of the NR network, an indication for indicating presence of the data of the MDT measurement of the NR network, when the UE enters the RRC connection state or an RRC recovery request state; and reporting the data of the MDT measurement of the NR network to the base station of the LTE or eLTE network or the base station of the NR network, when the UE receives an indication for reporting the data of the MDT measurement of the NR network, wherein the indication for reporting the data of the MDT measurement of the NR network is transmitted by the base station of the LTE or eLTE network or the base station of the NR network according to the indication for indicating the presence of the data of the MDT measurement of the NR network.

In a second embodiment, a base station of a NR network (a first network) is used to configure MDT measurement of an LTE or eLTE network (a second network).

Step 31: the base station of the NR network receives and stores information on whether a UE supports execution of the MDT measurement of the LTE or eLTE network.

In an embodiment of the present disclosure, when the UE initially accesses, if the UE supports the execution of the MDT measurement of the LTE or eLTE network, the information on whether the UE supports the execution of the MDT measurement of the LTE or eLTE network is transmitted to the base station of the NR network by using the following method in which: the network node HSS or MME directly transmits the information that the UE supports the execution of the MDT measurement of the LTE or eLTE network to the base station of the NR network; or the HSS transmits the information that the UE supports the execution of the MDT measurement of the LTE or eLTE network to the MME, and then the MME forwards the information to the base station of the NR network; or the MME transmits the information that the UE supports the execution of the MDT measurement of the LTE or eLTE network to the base station of the NR network; or the base station of the LTE or eLTE network transmits the information that the UE supports the execution of the MDT measurement of the LTE or eLTE network to the base station of the NR network; or the network node UDM or SMF or AMF directly transmits the information that the UE supports the execution of the MDT measurement of the LTE or eLTE network to the base station of the NR network; or the UDM transmits the information that the UE supports the execution of the MDT measurement of the LTE or eLTE network to the SMF, and then the SMF forwards the information to the AMF, and then the AMF forwards the information to the base station of the LTE or eLTE network, and then the base station of the LTE or eLTE network forwards the information to the base station of the NR network; or the SMF transmits the information that the UE supports the execution of the MDT measurement of the LTE or eLTE network to the AMF, and then the AMF forwards the information to the base station of the LTE or eLTE network, and then the base station of the LTE or eLTE network forwards the information to the base station of the NR network; or the network node UDM or SMF or AM directly transmits the information that the UE supports the execution of the MDT measurement of the NR network to the base station of the NR network; or the UDM transmits the information that the UE supports the execution of the MDT measurement of the NR network to the SMF, and then the SMF forwards the information to the AMF, and then the AMF forwards the information to the base station of the NR network; or the SMF transmits the information that the UE supports the execution of the MDT measurement of the NR network to the AMF, and then the AMF forwards the information to the base station of the NR network.

In an embodiment of the present disclosure, the information that the UE supports the execution of the MDT measurement of the LTE or eLTE network is included in UE context information or UE initial context establishing request information.

In an embodiment of the present disclosure, when the base station of the NR network receives the information that the UE supports the execution of the MDT measurement of the LTE or eLTE network, the base station will store the information that the UE supports the execution of the MDT measurement of the LTE or eLTE network; when the UE is being handed over from the base station of the NR network to a target base station, the information on whether the UE supports the execution of the MDT measurement of the LTE or eLTE network which corresponds to the UE being handed over is transmitted by the base station of the NR network to the target base station. In this way, the MDT measurement can be executed no matter on whichever the base station the UE is being handed over to. The information on whether the UE supports the execution of the MDT measurement of the LTE or eLTE network may be included in handover request information or other signaling. Once receiving the information on whether the UE supports the execution of the MDT measurement of the LTE or eLTE network, the target base station will store the information on whether the UE supports the execution of the MDT measurement of the LTE or eLTE network.

Step 32: the base station of the NR network receives the MDT tracking report information of the LTE or eLTE network transmitted by the network manager.

The MDT tracking report information of the LTE or eLTE network may include at least one of the following parameters.

1). A MDT measurement type, wherein the MDT measurement type includes: a logged MDT or an immediate MDT.

2). A MDT measurement area parameter, that is, a parameter indicating which regions need to activate the MDT measurement, wherein the MDT measurement area parameter may include a network slice list, an RAN paging area, an RAN notification area, an RAN location area, a system information area, a CN tracking area, or network cell information such as a cell PCI.

3). A measurement list, wherein the measurement list may include:

31). a UE measurement list, wherein the UE measurement list may include at least one of the following parameters:
a PH;
a RSRP/RSRQ/SINR of an SS block, a PSS and a SSS of the SS block, and a related PBCH;
measurement of the PSS and the SSS, which may include beam time index;
measurement of the PBCH, which may include measurement of a DMRS and related beam information;
measurement of the RSRP/RSRQ/SINR of a CSI-RS;
measurement information of a TRS/a PTRS;

32). a base station measurement list, wherein the base station measurement list may include at least one of the following parameters:
a RIP measurement;
a DV measurement, including a DL and/or an UL;
a SIT.

4). A condition for reporting the MDT measurement, including the reporting by the UE and/or the base station.

5). An MDT measurement reporting interval.

6). A value of reported MDT measurement.

7). An event threshold, such as an RSRP threshold and/or an RSRQ threshold.

8). An MDT measurement recording interval.

9). An MDT measurement recording duration.

10). A trace reference.

11). An MDT TCE IP address.

12). An MDT data anonymization.

13). A measurement period, such as a DV and/or SIT measurement period.

14). A RRM measurement period, such as a PH measurement and/or RIP measurement period.

15). A positioning method, including a GPS, an OTDOA and the like.

16). An MDT PLMN list.

In an embodiment of the present disclosure, the base station of the NR network is configured to determine, based on the information about the configuration of the MDT measurement of the LTE or eLTE network, whether the UE is in an area specified by the information about the configuration of the MDT measurement of the LTE or eLTE network, and determine, based on the stored information on whether the UE supports the execution of the MDT measurement of the LTE or eLTE network, whether the UE supports the execution of the MDT measurement of the LTE or eLTE network; select, when the UE is located in the area specified by the information about the configuration of the MDT measurement of the LTE or eLTE network and supports the execution of the MDT measurement of the LTE or eLTE network, the UE to execute the MDT measurement of the LTE or eLTE network; and not select, when the UE is not located in the area specified by the information about the configuration of the MDT measurement of the LTE or eLTE network or does not support the execution of the MDT measurement of the LTE or eLTE network, the UE to execute the MDT measurement of the LTE or eLTE network.

In an embodiment of the present disclosure, the base station of the NR network and the base station of the LTE or eLTE network may share the network manager. In this case, the step of receiving, by the base station of the NR network, the MDT tracking report information of the LTE or eLTE network transmitted by the network manager may include steps in which: the network manager directly transmits the MDT tracking report information to the base station of the NR network; or the network manager transmits the MDT tracking report information to the HSS, and then the HSS forwards the information to the base station of the NR network; or the network manager transmits the MDT tracking report information to the HSS, and then the HSS forwards the information to the MME, and then the MME forwards the information to the base station of the NR network.

In an embodiment of the present disclosure, the base station of the LTE or eLTE network and the base station of the NR network may correspond to respective independent network managers. In this case, the step of receiving, by the base station of the NR network, the MDT tracking report information of the LTE or eLTE network transmitted by the network manager may include: the network manager of the LTE or eLTE network transmits the MDT tracking report information to the network manager of the NR network, and then the network manager of the NR network transmits the information to the base station of the NR network; or the network manager of the LTE or eLTE network transmits the MDT tracking report information to the HSS, and then the HSS forwards the information to the base station of the NR network; or the network manager of the LTE or eLTE network transmits the MDT tracking report information to the HSS, and then the HSS forwards the information to the MME, and then the MME forwards the information to the base station of the NR network.

Step 33: the base station of the NR network is configured to select, based on the MDT tracking report information and the stored information on whether UE supports the execution of the MDT measurement of the LTE or eLTE network, the UE to execute the MDT measurement of the LTE or eLTE network; transmit, to the selected UE, the information about the configuration for activating the UE to execute the MDT measurement of the LTE or eLTE network.

In an embodiment of the present disclosure, the base station of the NR network may transmit, to the selected UE, the information about the configuration for activating the UE to execute the MDT measurement of the LTE or eLTE network through any one or more of an RRC reconfiguration message, an RRC recovery message, an RRC suspending message, an RRC releasing message and an RRC connection establishment message.

In an embodiment of the present disclosure, when the UE receives, from the base station of the NR network, the information about the configuration for activating the UE to execute the MDT measurement of the LTE or eLTE network, the UE may execute the MDT measurement of the LTE or eLTE network based on the information about the configuration for activating the UE to execute the MDT measurement of the LTE or eLTE network, record the data of the MDT measurement, and report the data to the network.

The information about the configuration for activating the UE to execute the MDT measurement of the LTE or eLTE network includes a type of the MDT measurement, wherein the type of the MDT measurement is a logged MDT or an immediate MDT. When the type of the MDT measurement is the immediate MDT, the step of reporting, by the UE, the data of the MDT measurement of the LTE or eLTE network includes: reporting the data of the MDT measurement of the NR network to the base station of the LTE or eLTE network or the base station of the NR network, when the UE is in an RRC connection state or a RRC inactive state.

When the type of the MDT measurement is the logged MDT, the step of reporting, by the UE, the data of the MDT measurement of the LTE or eLTE network includes: transmitting, by the UE to the base station of the LTE or eLTE network and/or the base station of the NR network, an indication for indicating presence of the data of the MDT measurement of the LTE or eLTE network, when the UE enters the RRC connection state or an RRC recovery request state; and reporting the data of the MDT measurement of the LTE or eLTE network to the base station of the LTE or eLTE network or the base station of the NR network, when the UE receives an indication for reporting the data of the MDT measurement of the LTE or eLTE network, wherein the indication for reporting the data of the MDT measurement of the LTE or eLTE network is transmitted by the base station of the LTE or eLTE network or the base station of the NR network according to the indication for indicating the presence of the data of the MDT measurement of the LTE or eLTE network.

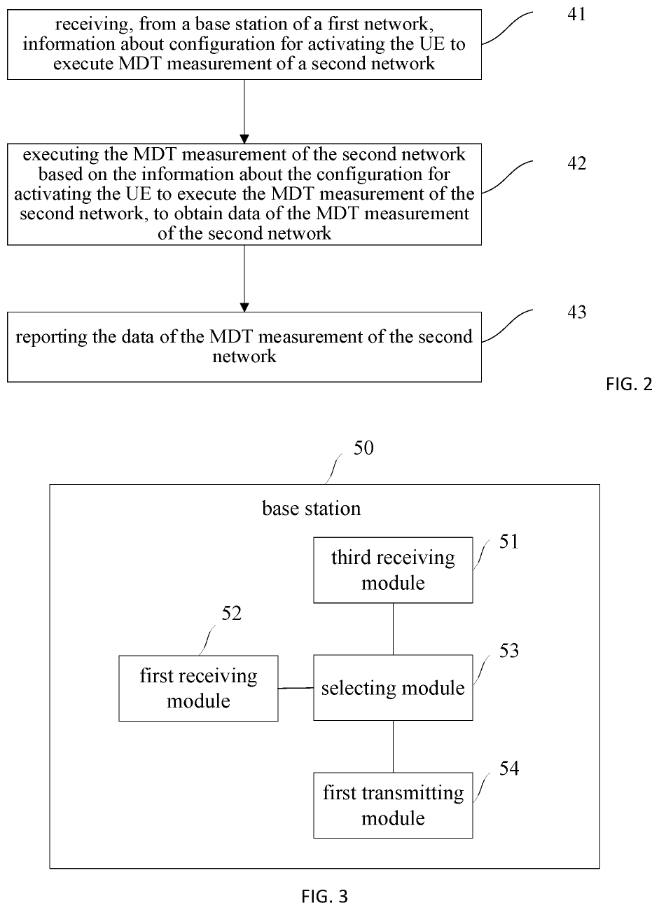

Referring to FIG. 2, an embodiment of the present disclosure further provides a method for MDT measurement, which is applied to a UE and includes following steps.

Step 41: receiving, from a base station of a first network, information about configuration for activating the UE to execute MDT measurement of a second network.

Step 42: executing the MDT measurement of the second network based on the information about the configuration for activating the UE to execute the MDT measurement of the second network, to obtain data of the MDT measurement of the second network.

Step 43: reporting the data of the MDT measurement of the second network.

In an embodiment of the present disclosure, the UE is configured to receive, from the base station of the first network, the information about the configuration for activating the UE to execute the MDT measurement of the second network; and execute the MDT measurement of the second network. In this way, the base station of the first network can control as well the UE to execute the configuration of the MDT measurement of the second network, so that the configuration of the MDT measurement and the MDT measurement may be implemented in the heterogeneous network, thereby improving the compatibility of the MDT measurement in the heterogeneous network.

Optionally, the information about the configuration for activating the UE to execute the MDT measurement of the second network includes a type of the MDT measurement, wherein the type of the MDT measurement is a logged MDT or an immediate MDT.

When the type of the MDT measurement is the immediate MDT, the step of reporting, by the UE, the data of the MDT measurement of the second network includes: reporting the data of the MDT measurement of the second network to the base station of the first network or a base station of the second network, when the UE is in an RRC connection state or a RRC inactive state. When the type of the MDT measurement is the logged MDT, the step of reporting, by the UE, the data of the MDT measurement of the second network includes: transmitting, by the UE to the base station of the first network and/or the base station of the second network, an indication for indicating presence of the data of the MDT measurement of the second network, when the UE enters the RRC connection state or an RRC recovery request state; and reporting the data of the MDT measurement of the second network to the base station of the first network or the base station of the second network, when the UE receives an indication for reporting the data of the MDT measurement of the second network, wherein the indication for reporting the data of the MDT measurement of the second network is transmitted by the base station of the first network or the base station of the second network according to the indication for indicating the presence of the data of the MDT measurement of the second network.

Reference is made to FIG. 3. Based on the same inventive concept, an embodiment of the present disclosure further provides a base station 50, which is located in a first network and includes: a storing module 51, configured to store information on whether a UE supports execution of MDT measurement of a second network; a first receiving module 52, configured to receive information about configuration of the MDT measurement of the second network transmitted by a network manager; a selecting module 53, configured to select, based on the information about the configuration of the MDT measurement and the stored information on whether the UE supports the execution of the MDT measurement of the second network, a UE for executing the MDT measurement of the second network; and a first transmitting module 54, configured to transmit, to the selected UE, information about configuration for activating the UE to execute the MDT measurement of the second network.

Optionally, the transmitting module is configured to transmit to the selected UE the information about the configuration for activating the UE to execute the MDT measurement of the second network, when the selected UE is in a non-idle state. The non-idle state includes a RRC connection state, a RRC inactive state, an RRC-recovery-request initiating state, a service-request initiating state, an access-notification-area-update initiating state, and a tracking-area-update initiating state.

Optionally, the base station further includes: a second receiving module, configured to receive the information on whether the UE supports the execution of the MDT measurement of the second network, wherein the information on whether the UE supports the execution of the MDT measurement of the second network is transmitted by a network node of the first network, or transmitted by a base station of the second network, or transmitted by a network node of the second network, or forwarded by a network node of the second network through a base station of the second network.

Optionally, the information on whether the UE supports the execution of the MDT measurement of the second network is included in UE context information or UE initial context establishing request information.

Optionally, the base station further includes: a second transmitting module, configured to transmit, when the UE is being handed over from the base station of the first network to a target base station, information on whether the UE supports the execution of the MDT measurement of the second network which corresponds to the UE being handed over, to the target base station.

Optionally, the selecting module is configured to: determine, based on the information about the configuration of the MDT measurement of the second network, whether the UE is in an area specified by the information about the configuration of the MDT measurement of the second network, and determine, based on the stored information on whether the UE supports the execution of the MDT measurement of the second network, whether the UE supports the execution of the MDT measurement of the second network; select, when the UE is located in the area specified by the information about the configuration of the MDT measurement of the second network and supports the execution of the MDT measurement of the second network, the UE to execute the MDT measurement of the second network; and not selecting, when the UE is not located in the area specified by the information about the configuration of the MDT measurement of the second network or does not support the execution of the MDT measurement of the second network, the UE to execute the MDT measurement of the second network.

Optionally, the base station of the first network and the base station of the second network share the network manager.

In this case, the first receiving module is configured to: receive the information about the configuration of the MDT measurement of the second network directly transmitted by the network manager; or receive the information about the configuration of the MDT measurement of the second network forwarded by the network manager through the network node of the first network.

Optionally, the base station of the first network and the base station of the second network correspond to respective independent network managers. The first receiving module is configured to: receive the information about the configuration of the MDT measurement of the second network forwarded by the network manager of the second network through the network manager of the first network, wherein the network manager of the first network receives the information about the configuration of the MDT measurement of the second network, and directly forwards the received information about the configuration of the MDT measurement of the second network to the base station of the first network; or the network manager of the first network receives the information about the configuration of the MDT measurement of the second network, and forwards the received information about the configuration of the MDT measurement of the second network to the base station of the first network through the network node of the first network. Alternatively, the first receiving module is configured to: receive the information about the configuration of the MDT measurement of the second network forwarded by the network manager of the second network through the base station of the second network, wherein the network manager of the second network directly transmits the information about the configuration of the MDT measurement of the second network to the base station of the second network, and the base station of the second network forwards the information about the configuration of the MDT measurement of the second network to the base station of the first network; or the network manager of the second network transmits the information about the configuration of the MDT measurement of the second network to the network node of the second network, the network node of the second network forwards the information about the configuration of the MDT measurement of the second network to the base station of the second network, and the base station of the second network forwards the information about the configuration of the MDT measurement of the second network to the base station of the first network.

Optionally, the first transmitting module is configured to transmit to the selected UE the information about the configuration for activating the UE to execute the MDT measurement of the second network through any one or more of an RRC reconfiguration message, an RRC recovery message, an RRC suspending message, an RRC releasing message and an RRC connection establishment message.

In an embodiment of the present disclosure, the base station may be a Base Transceiver Station (BTS) in Global System of Mobile communication (GSM) or Code Division Multiple Access (CDMA), or may be a Node B (NB) in Wideband Code Division Multiple Access (WCDMA), or may be an evolutional Node B (eNB or eNodeB) in the LTE, or may be a relay station or access point, or may be a base station in the future 5G network, etc, which is not limited herein.

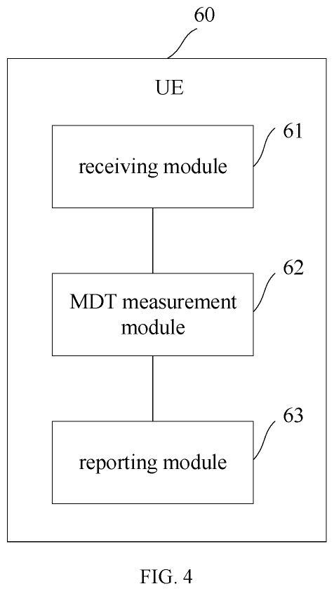

Referring to FIG. 4, an embodiment of the present disclosure further provides a UE 60. The UE 60 includes: a receiving module 61, configured to receive, from a base station of a first network, information about configuration for activating the UE to execute MDT measurement of a second network; an MDT measurement module 62, configured to execute the MDT measurement of the second network based on the information about the configuration for activating the UE to execute the MDT measurement of the second network, to obtain data of the MDT measurement of the second network; and a reporting module 63, configured to report the data of the MDT measurement of the second network.

Optionally, the information about the configuration for activating the UE to execute the MDT measurement of the second network includes a type of the MDT measurement, wherein the type of the MDT measurement is a logged MDT or an immediate MDT.

When the type of the MDT measurement is the immediate MDT, the reporting module is configured to: reporting the data of the MDT measurement of the second network to the base station of the first network or a base station of the second network, when the UE is in a RRC connection state or a RRC inactive state.

When the type of the MDT measurement is the logged MDT, the reporting module is configured to: transmit, by the UE to the base station of the first network and/or the base station of the second network, an indication for indicating presence of the data of the MDT measurement of the second network, when the UE enters the RRC connection state or an RRC recovery request state; and report the data of the MDT measurement of the second network to the base station of the first network or the base station of the second network, when the UE receives an indication for reporting the data of the MDT measurement of the second network, wherein the indication for reporting the data of the MDT measurement of the second network is transmitted by the base station of the first network or the base station of the second network according to the indication for indicating the presence of the data of the MDT measurement of the second network.

In an embodiment of the present disclosure, the UE may be a wireless terminal or a wired terminal. The wireless terminal may be a device that provides voice and/or other service data connectivity to the user, a handheld device with a wireless connection function, or another processing device connected to a wireless modem. A wireless terminal may communicate with one or more core networks via a RAN. The wireless terminal may be a mobile terminal, such as a mobile phone (or “cellular” phone) and a computer with a mobile terminal. For example, the wireless terminal may be a portable, pocketable, handheld, computer-embedded or vehicle-mounted mobile device that exchanges languages and/or data with a wireless access network, e.g., a device such as a Personal Communication Service (PCS) phone, a cordless phone, a Session Initiation Protocol (SIP) phone, a Wireless Local Loop (WLL) station, a Personal Digital Assistant (PDA) or the like. A wireless terminal may also be called as a system, a subscriber unit, a subscriber station, a mobile station, a mobile, a remote station, a remote terminal, an access terminal, a user terminal, a user agent, a user device or user equipment, which is not limited here.

An embodiment of the present disclosure further provides a base station including: a memory, a processor, and a computer program stored in the memory and capable of being executed by the processor, wherein the processor is configured to execute the computer program to implement steps of the method for configuring the MDT.

An embodiment of the present disclosure further provides a UE including: a memory, a processor, and a computer program stored in the memory and capable of being executed by the processor, wherein the processor is configured to execute the computer program to implement steps of the method for the MDT measurement.

An embodiment of the present disclosure further provides a computer-readable storage medium storing therein a computer program, wherein the computer program is executed by a processor, to implement steps of the method for configuring the MDT.

An embodiment of the present disclosure further provides a computer-readable storage medium storing therein a computer program, wherein the computer program is executed by a processor, to implement steps of the method for the MDT measurement.

The computer-readable storage medium may be, e.g., a Read-Only Memory (ROM), a Random Access Memory (RAM), a magnetic disk, or an optical disk.

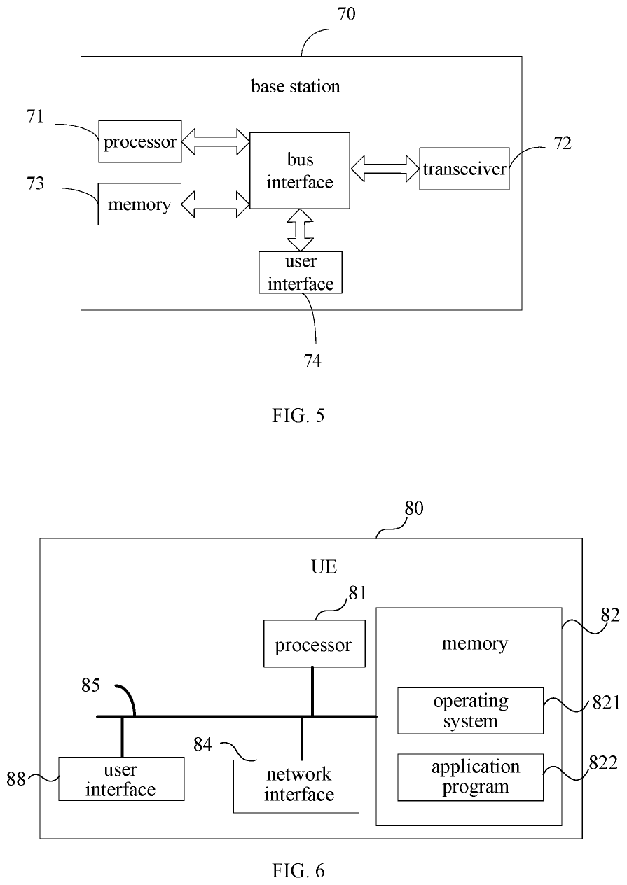

Referring to FIG. 5, an embodiment of the present disclosure further provides a base station 70, which is located in the first network. The base station 70 includes: a processor 71, a transceiver 72, a memory 73, a user interface 74, and a bus interface.

In an embodiment of the present disclosure, the base station 70 further includes a computer program stored in the memory 73 and capable of being executed by the processor 71. The processor 71 is used to execute the computer program to implement steps of: storing information on whether a UE supports execution of MDT measurement of a second network; receiving information about configuration of the MDT measurement of the second network transmitted by a network manager; selecting, based on the information about the configuration of the MDT measurement and the stored information on whether the UE supports the execution of the MDT measurement of the second network, a UE for executing the MDT measurement of the second network; and transmitting, to the selected UE, information about configuration for activating the UE to execute the MDT measurement of the second network.

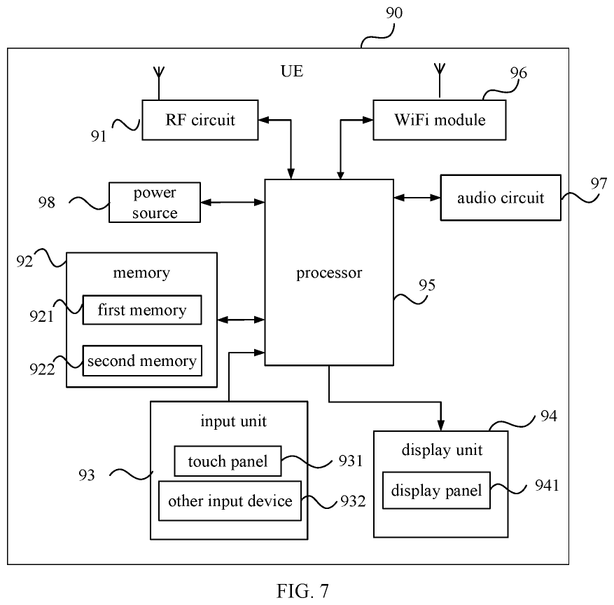

In FIG. 7, a bus architecture may include any number of interconnected buses and bridges, and connects various circuits including specifically one or more processors represented by the processor 71 and storages represented by the memory 73. The bus architecture may also connect various other circuits such as peripherals, voltage regulators and power management circuits, which is well known in the art. Therefore, a detailed description thereof is omitted herein. A bus interface are provided. The transceiver 72 may include multiple elements, i.e., including a transmitter and a transceiver, to provide units allowed for communication with various other devices on the transmission medium. For various UEs, the user interface 74 may also be an interface providing internal and external connections to required devices. The connected devices may include, but are not limited to, a keypad, a display, a speaker, a microphone, a joystick, and the like

The processor 71 is responsible for supervising the bus architecture and normal operation and the memory 73 may store the data being used by the first processor 71 during operation.

Optionally, the step of transmitting, to the selected UE, the information about the configuration for activating the UE to execute the MDT measurement of the second network includes: transmitting to the selected UE the information about the configuration for activating the UE to execute the MDT measurement of the second network, when the selected UE is in a non-idle state; the non-idle state includes a RRC connection state, a RRC inactive state, an RRC-recovery-request initiating state, a service-request initiating state, an access-notification-area-update initiating state, and a tracking-area-update initiating state.

Optionally, it further includes: before the step of storing, by the base station of the first network, the information on whether the UE supports the execution of the MDT measurement of the second network: receiving the information on whether the UE supports the execution of the MDT measurement of the second network, wherein the information on whether the UE supports the execution of the MDT measurement of the second network is transmitted by a network node of the first network, or transmitted by a base station of the second network, or transmitted by a network node of the second network, or forwarded by a network node of the second network through a base station of the second network.

Optionally, the information on whether the UE supports the execution of the MDT measurement of the second network is included in UE context information or UE initial context establishing request information.

Optionally, it further includes: after the step of storing, by the base station of the first network, the information on whether the UE supports the execution of the MDT measurement of the second network: transmitting, by the base station of the first network, when the UE is being handed over from the base station of the first network to a target base station, information on whether the UE supports the execution of the MDT measurement of the second network which corresponds to the UE being handed over, to the target base station.

Optionally, the step of selecting, based on the information about the configuration of the MDT measurement and the stored information on whether the UE supports the execution of the MDT measurement of the second network, the UE for executing the MDT measurement of the second network includes: determining, based on the information about the configuration of the MDT measurement of the second network, whether the UE is in an area specified by the information about the configuration of the MDT measurement of the second network, and determining, based on the stored information on whether the UE supports the execution of the MDT measurement of the second network, whether the UE supports the execution of the MDT measurement of the second network; selecting, when the UE is located in the area specified by the information about the configuration of the MDT measurement of the second network and supports the execution of the MDT measurement of the second network, the UE to execute the MDT measurement of the second network; and not selecting, when the UE is not located in the area specified by the information about the configuration of the MDT measurement of the second network or does not support the execution of the MDT measurement of the second network, the UE to execute the MDT measurement of the second network.

Optionally, the base station of the first network and the base station of the second network share the network manager, and the step of receiving the information about the configuration of the MDT measurement of the second network transmitted by the network manager includes: receiving the information about the configuration of the MDT measurement of the second network directly transmitted by the network manager; or receiving the information about the configuration of the MDT measurement of the second network forwarded by the network manager through the network node of the first network.

Optionally, the base station of the first network and the base station of the second network correspond to respective independent network managers, and the step of receiving the information about the configuration of the MDT measurement of the second network transmitted by the network manager includes: receiving the information about the configuration of the MDT measurement of the second network forwarded by the network manager of the second network through the network manager of the first network, wherein the network manager of the first network receives the information about the configuration of the MDT measurement of the second network, and directly forwards the received information about the configuration of the MDT measurement of the second network to the base station of the first network; or the network manager of the first network receives the information about the configuration of the MDT measurement of the second network, and forwards the received information about the configuration of the MDT measurement of the second network to the base station of the first network through the network node of the first network; or receiving the information about the configuration of the MDT measurement of the second network forwarded by the network manager of the second network through the base station of the second network, wherein the network manager of the second network directly transmits the information about the configuration of the MDT measurement of the second network to the base station of the second network, and the base station of the second network forwards the information about the configuration of the MDT measurement of the second network to the base station of the first network; or the network manager of the second network transmits the information about the configuration of the MDT measurement of the second network to the network node of the second network, the network node of the second network forwards the information about the configuration of the MDT measurement of the second network to the base station of the second network, and the base station of the second network forwards the information about the configuration of the MDT measurement of the second network to the base station of the first network.

Optionally, the step of transmitting to the selected UE the information about the configuration for activating the UE to execute the MDT measurement of the second network includes: transmitting to the selected UE the information about the configuration for activating the UE to execute the MDT measurement of the second network through any one or more of an RRC reconfiguration message, an RRC recovery message, an RRC suspending message, an RRC releasing message and an RRC connection establishment message.

According to an embodiment of the present disclosure, the base station of the first network is configured to store the information on whether the UE supports the execution of the MDT measurement of the second network, receive the information about the configuration of the MDT measurement of the second network transmitted by the network manager, select a UE for executing the MDT measurement of the second network, and transmit, to the selected UE, the information about configuration for activating the UE to execute the MDT measurement of the second network. In this way, the base station of the first network can control as well the UE to execute the configuration of the MDT measurement of the second network, so that the configuration of the MDT measurement and the MDT measurement may be implemented in the heterogeneous network, thereby improving the compatibility of the MDT measurement in the heterogeneous network.

Referring to FIG. 6, an sixth embodiment of the present disclosure provides a UE 80. As shown in FIG. 6, the UE 80 includes: at least one processor 81, a memory 82, at least one network interface 84, and other user interface 83. Various components in UE 80 are coupled together by a bus system 85. It should be appreciated that the bus system 85 is used to implement connection communication between these components. In addition to a data bus, the bus system 85 further includes a power bus, a control bus, and a status signal bus. However, for clarity of description, various buses are labeled as the bus system 85 in FIG. 6.

The user interface 83 may include a display, a keyboard, or a pointing device (e.g., a mouse, a trackball, a touch pad, or a touch screen, etc.).

It should be appreciated that the memory 82 in the embodiments of the present disclosure may be a volatile memory or a non-volatile memory, or may include both volatile and non-volatile memories. The non-volatile memory may be a Read-Only Memory (ROM), a Programmable Read-Only Memory (PROM), an Erasable Programmable Read Only Memory (EPROM), or an Electronically Erasable Programmable Read Only Memory (EEPROM) or flash memory. The volatile memory can be a Random Access Memory (RAM) that acts as an external cache. By way of example and not limitation, many forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), Synch Link Dynamic Random Access Memory (SLDRAM) and Direct Rambus Random Access Memory (DRRAM). The memory 82 of the systems and methods described herein is intended to include, without being limited to, these and any other suitable types of memory.

In some implementations, the memory 82 stores following elements: executable modules or data structures, or a subset thereof, or an extended set thereof: an operating system 821 and an application program 822.

The operating system 821 includes various system programs, such as a framework layer, a core library layer and a driver layer, for implementing various basic services and processing hardware-based tasks. The application program 822 includes various application programs, such as a Media Player, a Browser, for implementing various application services. A program implementing the method of the embodiments of the present disclosure may be included in the application program 822.

The UE 80 further includes a program stored in the memory 82 and capable of being executed by the processor 81. Specifically, it may be a computer program stored in the application program 822, and the processor 81 is configured to execute the program to implement following steps: receiving, from a base station of a first network, information about configuration for activating the UE to execute MDT measurement of a second network; executing the MDT measurement of the second network based on the information about the configuration for activating the UE to execute the MDT measurement of the second network, to obtain data of the MDT measurement of the second network; and reporting the data of the MDT measurement of the second network.

The method disclosed in the above embodiments of the present disclosure may be applied to the processor 81 or implemented by the processor 81. The processor 81 may be an integrated circuit chip with signal processing capabilities. In an implementation process, each step of the above method may be completed by an integrated logic circuit of hardware in the processor 81 or an instruction in a form of software. The processor 81 may be a general-purpose processor, a Digital Signal Processor (DSP), an Application Specific Integrated Circuit (ASIC), a Field Programmable Gate Array (FPGA), or another programmable logic device, a discrete gate or transistor logic device, or a discrete hardware component. Various methods, steps, and logical block diagrams disclosed in the embodiments of the present disclosure may be implemented or executed. The general-purpose processor may be a microprocessor, or the processor may be any conventional processor or the like. The steps of the method disclosed in combination with the embodiments of the present disclosure may be directly embodied as being executed by a hardware decoding processor, or being executed by a combination of hardware and software modules in a decoding processor. The software module can be located in a well-established storage medium in the art, such as random access memory, flash memory, read-only memory, programmable read-only memory or electrically erasable programmable memory, registers. The storage medium is located in the memory 82, and the processor 81 reads information in the memory 82 and implements the steps of the above method in combination with its hardware.

It should be appreciated that the embodiments described herein can be implemented by hardware, software, firmware, middleware, microcode, or a combination thereof. For hardware implementation, the processing unit can be implemented in one or more Application Specific Integrated Circuits (ASICs), Digital Signal Processor (DSPs), Digital Signal Processing Devices (DSPDs), Programmable Logic Devices (PLDs), Field Programmable Gate Arrays (FPGAs), general purpose processors, controllers, microcontrollers, microprocessors, other electronic units for performing functions described in the present application or a combination thereof.

For software implementation, techniques described herein may be implemented by modules (such as procedures, functions) that perform the functions described herein. Software codes can be stored in a memory and executed by a processor. The memory can be implemented in the processor or external to the processor.

Optionally, in another embodiment, the information about the configuration for activating the UE to execute the MDT measurement of the second network includes a type of the MDT measurement, wherein the type of the MDT measurement is a logged MDT or an immediate MDT. When the type of the MDT measurement is the immediate MDT, the step of reporting, by the UE, the data of the MDT measurement of the second network includes: reporting the data of the MDT measurement of the second network to the base station of the first network or a base station of the second network, when the UE is in an RRC connection state or a RRC inactive state. When the type of the MDT measurement is the logged MDT, the step of reporting, by the UE, the data of the MDT measurement of the second network includes: transmitting, by the UE to the base station of the first network and/or the base station of the second network, an indication for indicating presence of the data of the MDT measurement of the second network, when the UE enters the RRC connection state or an RRC recovery request state; and reporting the data of the MDT measurement of the second network to the base station of the first network or the base station of the second network, when the UE receives an indication for reporting the data of the MDT measurement of the second network, wherein the indication for reporting the data of the MDT measurement of the second network is transmitted by the base station of the first network or the base station of the second network according to the indication for indicating the presence of the data of the MDT measurement of the second network.

The UE 80 can implement the processes implemented by the UE in the foregoing embodiments. A detailed description thereof is not repeated herein.

In an embodiment of the present disclosure, the UE 80 is configured to receive, from the base station of the first network, the information about the configuration for activating the UE to execute the MDT measurement of the second network, and execute the MDT measurement of the second network. In this way, the base station of the first network can control as well the UE to execute the configuration of the MDT measurement of the second network, so that the configuration of the MDT measurement and the MDT measurement may be implemented in the heterogeneous network, thereby improving the compatibility of the MDT measurement in the heterogeneous network.

Referring to FIG. 7, an embodiment of the present disclosure further provides a UE 90. In particular, the UE 90 shown in FIG. 7 may be a mobile phone, a tablet computer, a Personal Digital Assistant, (PDA), or a vehicle-mounted computer.

The UE 90 shown in FIG. 7 includes a Radio Frequency (RF) circuit 91, a memory 92, an input unit 93, a display unit 94, a processor 95, a Wireless Fidelity (WiFi) module 96, an audio circuit 99, and a power source 98.

The input unit 93 may be configure to receive digital or character information input by the user, and generate signal input related to a user setting and a function control of the UE 90.

Specifically, in an embodiment of the present disclosure, the input unit 93 may include a touch panel 931. The touch panel 931, also known as a touch screen, can collect the user's touch operations on or near the touch panel 931 (such as the operation of the user on the touch panel 931 using any suitable object or accessory such as a finger, a stylus), and drive the respective connected device according to a preset program. Optionally, the touch panel 931 may include a touch detection device and a touch controller. The touch detection device is configured to detect the user's touch position, detect the signal caused by the touch operation, and transmit the signal to the touch controller. The touch controller is configured to receive touch information from the touch detection device, convert the information into a contact coordinate, transmit the contact coordinate to the processor 95, and receive and execute command from processor 95. In addition, various types such as resistive, capacitive, infrared, and surface acoustic wave may be used to implement the touch panel 931. In addition to the touch panel 931, the input unit 93 may further include other input device 932. The other input device 932 may include one or more of, but are not limited to, a physical keyboard, a function key (such as a volume control key, a switch key, etc.), a trackball, and a mouse, a joystick and the like.

The display unit 94 may be configured to display information inputted by the user or information provided to the user as well as various menu interfaces of the UE 90. The display unit 94 may include a display panel 941. Optionally, a Liquid Crystal Display (LCD) or an Organic Light-Emitting Diode (OLED), etc., can be employed to form the display panel 941.

It should be noted that the touch panel 931 can cover the display panel 941 to form a touch display screen. When the touch display screen detects the touch operation on or near the touch display screen, the touch display screen will transmit it to the processor 95 to determine the type of touch event. Then, the processor 95 provides a respective visual output on the touch display screen according to the type of touch event.

The touch display screen includes an application program interface displaying area and a common control displaying area. The arrangement of the application program interface displaying area and the common control displaying area is not limited, such as an up-and-down arrangement, or a left-and-right arrangement, as long as the two displaying areas may be distinguished from each other. The application program interface displaying area may be used to display the interface of the application program. Each interface may include interface elements such as an icon of at least one application program and/or a widget desktop control. The application program interface displaying area may also be an empty interface without any content. The common control displaying area is configured to display controls with high usage, such as a setting button, an interface number, a scroll bar, an icon of application program such as a phonebook icon, and the like.

In an embodiment of the present disclosure, by calling a software program and/or a module stored in the first memory 921 and/or data within the second memory 922, the computer program is executed by a processor 95 to implement following steps: receiving, from a base station of a first network, information about configuration for activating the UE to execute MDT measurement of a second network; executing the MDT measurement of the second network based on the information about the configuration for activating the UE to execute the MDT measurement of the second network, to obtain data of the MDT measurement of the second network; and reporting the data of the MDT measurement of the second network.

Optionally, in another embodiment, the information about the configuration for activating the UE to execute the MDT measurement of the second network includes a type of the MDT measurement, wherein the type of the MDT measurement is a logged MDT or an immediate MDT. When the type of the MDT measurement is the immediate MDT, the step of reporting, by the UE, the data of the MDT measurement of the second network includes: reporting the data of the MDT measurement of the second network to the base station of the first network or a base station of the second network, when the UE is in an RRC connection state or a RRC inactive state. When the type of the MDT measurement is the logged MDT, the step of reporting, by the UE, the data of the MDT measurement of the second network includes: transmitting, by the UE to the base station of the first network and/or the base station of the second network, an indication for indicating presence of the data of the MDT measurement of the second network, when the UE enters the RRC connection state or an RRC recovery request state; and reporting the data of the MDT measurement of the second network to the base station of the first network or the base station of the second network, when the UE receives an indication for reporting the data of the MDT measurement of the second network, wherein the indication for reporting the data of the MDT measurement of the second network is transmitted by the base station of the first network or the base station of the second network according to the indication for indicating the presence of the data of the MDT measurement of the second network.

The UE 90 can implement the processes implemented by the UE in the foregoing embodiments. A detailed description thereof is not repeated herein.

In an embodiment of the present disclosure, the UE 90 is configured to receive, from the base station of the first network, the information about the configuration for activating the UE to execute the MDT measurement of the second network; and execute the MDT measurement of the second network. In this way, the base station of the first network can control as well the UE to execute the configuration of the MDT measurement of the second network, so that the configuration of the MDT measurement and the MDT measurement may be implemented in the heterogeneous network, thereby improving the compatibility of the MDT measurement in the heterogeneous network.

A person skilled in the art may realize that units and algorithm steps of each example described in combination with the embodiments disclosed herein may be implemented in electronic hardware or a combination of computer software and electronic hardware. Whether these functions are performed in hardware or software depends on specific applications and design constraints of the technical solution. A professional technician can use different methods to implement described functions for each specific application, but such implementation should not be considered beyond the scope of the present disclosure.

A person skilled in the art may clearly understand that, for convenience and brevity of the description, specific working process of the system, the device and the unit described above may refer to the corresponding process in the above method embodiments, which will not be repeated herein.

In the embodiments provided by the present application, it should be appreciated that the disclosed device and method may be implemented in other manners. For example, the device embodiments described above are merely illustrative. For example, division of the units is merely a logical function division. In actual implementations, there may be another division manner. For example, multiple units or components may be combined, or may be integrated into another system, or some features may be ignored or not executed. In addition, coupling or direct coupling or communication connection between the components shown or discussed may be indirect coupling or a communication connection through some interfaces, devices or units, and may be electrical, mechanical or other forms.

The units described as separate components may or may not be physically separated, and the components displayed as the units may or may not be physical units, that is, they may be located in one place or distributed to multiple network units. Some or all of the units may be selected according to actual needs to achieve objectives of the embodiments.

In addition, different functional units in different embodiments of the present disclosure may be integrated into one processing unit, or may physically exist separately, or two or more units may be integrated into one unit.

When the functions are implemented in a form of software functional units and sold or used as independent products, they may be stored in a computer-readable storage medium. Based on this understanding, the technical solution of the present disclosure essentially, or a part that contributes to the prior art, or a part of the technical solution may be embodied in a form of a software product. The computer software product is stored in a storage medium and includes instructions for causing a computer device (for example, a personal computer, a server, or a network device) to perform all or part of the steps of the method described in various embodiments of the present disclosure. The above storage medium includes various media that can store program codes, such as a Universal Serial Bus (USB) flash disk, a mobile hard disk, a ROM, a RAM, a magnetic disk, or an optical disk, and the like.

The above content is only the specific embodiments of the present disclosure, but the scope of the present disclosure is not limited thereto. Any changes or substitutions easily conceived by a person skilled in the art in the technical scope of the disclosure should fall within the protection scope of the disclosure. Therefore, the protection scope of the present disclosure should be determined by the scope of the appended claims.

What is claimed is:

1. A method for configuring Minimization of Drive-Test (MDT), which is applied to a base station of a first network, and comprises:
receiving information on whether a User Equipment (UE) supports execution of MDT measurement of a second network;
receiving information about configuration of the MDT measurement of the second network transmitted by a network manager;
selecting, based on the information about the configuration of the MDT measurement and the information on whether the UE supports the execution of the MDT measurement of the second network, a UE for executing the MDT measurement of the second network; and
transmitting, to the selected UE, information about configuration for activating the UE to execute the MDT measurement of the second network.

2. The method according to claim 1, wherein transmitting, to the selected UE, the information about configuration for activating the UE to execute the MDT measurement of the second network comprises:
transmitting to the selected UE the information about the configuration for activating the UE to execute the MDT measurement of the second network, when the selected UE is in a non-idle state,
wherein the non-idle state comprises a Radio Resource Control (RRC) connection state, a RRC inactive state, a RRC-recovery-request initiating state, a service-request initiating state, an access-notification-area-update initiating state, and a tracking-area-update initiating state.

3. The method according to claim 1, wherein receiving, by the base station of the first network, the information on whether the UE supports the execution of the MDT measurement of the second network comprises:
receiving the information on whether the UE supports the execution of the MDT measurement of the second network, wherein the information on whether the UE supports the execution of the MDT measurement of the second network is transmitted by a network node of the first network, or transmitted by a base station of the second network, or transmitted by a network node of the second network, or forwarded by a network node of the second network through a base station of the second network.

4. The method according to claim 3, wherein the information on whether the UE supports the execution of the MDT measurement of the second network is comprised in UE context information or UE initial context establishing request information.

5. The method according to claim 1, further comprising: after receiving, by the base station of the first network, the information on whether the UE supports the execution of the MDT measurement of the second network,
transmitting, by the base station of the first network, when the UE is being handed over from the base station of the first network to a target base station, information on whether the UE supports the execution of the MDT measurement of the second network which corresponds to the UE being handed over, to the target base station.

6. The method according to claim 1, wherein selecting, based on the information about the configuration of the MDT measurement and the information on whether the UE supports the execution of the MDT measurement of the second network, the UE for executing the MDT measurement of the second network comprises:
selecting, when the UE is located in the area specified by the information about the configuration of the MDT measurement of the second network and supports the execution of the MDT measurement of the second network, the UE to execute the MDT measurement of the second network; and
not selecting, when the UE is not located in the area specified by the information about the configuration of the MDT measurement of the second network or does not support the execution of the MDT measurement of the second network, the UE to execute the MDT measurement of the second network.

7. The method according to claim 1, wherein the base station of the first network and the base station of the second network share the network manager, and receiving the information about the configuration of the MDT measurement of the second network transmitted by the network manager comprises:
receiving the information about the configuration of the MDT measurement of the second network directly transmitted by the network manager; or
receiving the information about the configuration of the MDT measurement of the second network forwarded by the network manager through the network node of the first network.

8. The method according to claim 1, wherein the base station of the first network and the base station of the second network correspond to respective independent network managers, and receiving the information about the configuration of the MDT measurement of the second network transmitted by the network manager comprises:
receiving the information about the configuration of the MDT measurement of the second network forwarded by the network manager of the second network through the network manager of the first network; or
receiving the information about the configuration of the MDT measurement of the second network forwarded by the network manager of the second network through the base station of the second network.

9. The method according to claim 7, wherein transmitting to the selected UE the information about the configuration for activating the UE to execute the MDT measurement of the second network comprises:
transmitting to the selected UE the information about the configuration for activating the UE to execute the MDT measurement of the second network through any one or more of an RRC reconfiguration message, an RRC recovery message, an RRC suspending message, an RRC releasing message and an RRC connection establishment message.

10. A method for MDT measurement, which is applied to a UE and comprises:
receiving, from a base station of a first network, information about configuration for activating the UE to execute MDT measurement of a second network;
executing the MDT measurement of the second network based on the information about the configuration for activating the UE to execute the MDT measurement of the second network, to obtain data of the MDT measurement of the second network; and
reporting the data of the MDT measurement of the second network.

11. The method according to claim 10, wherein the information about the configuration for activating the UE to execute the MDT measurement of the second network comprises a type of the MDT measurement, wherein the type of the MDT measurement is a logged MDT or an immediate MDT,
wherein when the type of the MDT measurement is the immediate MDT, reporting, by the UE, the data of the MDT measurement of the second network comprises:
reporting the data of the MDT measurement of the second network to the base station of the first network or a base station of the second network, when the UE is in a RRC connection state or a RRC inactive state; and
when the type of the MDT measurement is the logged MDT, reporting, by the UE, the data of the MDT measurement of the second network comprises:
transmitting, by the UE to the base station of the first network and/or the base station of the second network, an indication for indicating presence of the data of the MDT measurement of the second network, when the UE enters the RRC connection state or an RRC recovery request state;
reporting the data of the MDT measurement of the second network to the base station of the first network or the base station of the second network, when the UE receives an indication for reporting the data of the MDT measurement of the second network, wherein the indication for reporting the data of the MDT measurement of the second network is transmitted by the base station of the first network or the base station of the second network according to the indication for indicating the presence of the data of the MDT measurement of the second network.

12-22. (canceled)

23. A base station, comprising: a processor, a memory, and a program stored in the memory and capable of being executed by the processor, wherein the base station is a base station of a first network, the processor is configured to execute the program to:
receive information on whether a UE supports execution of MDT measurement of a second network;
receive information about configuration of the MDT measurement of the second network transmitted by a network manager;
select, based on the information about the configuration of the MDT measurement and the information on whether the UE supports the execution of the MDT measurement of the second network, a UE for executing the MDT measurement of the second network; and
transmit, to the selected UE, information about configuration for activating the UE to execute the MDT measurement of the second network.

24. A UE, comprising: a processor, a memory, and a program stored in the memory and capable of being executed by the processor, wherein the processor is configured to execute the program to implement the method for the MDT measurement according to claim 10.

25. (canceled)

26. The base station according to claim 23, wherein the processor is further configured to execute the program to:
transmit to the selected UE, the information about the configuration for activating the UE to execute the MDT measurement of the second network, when the selected UE is in a non-idle state,
wherein the non-idle state comprises a Radio Resource Control (RRC) connection state, a RRC inactive state, a RRC-recovery-request initiating state, a service-request initiating state, an access-notification-area-update initiating state, and a tracking-area-update initiating state.

27. The base station according to claim 23, wherein the processor is further configured to execute the program to: before receiving, by the base station of the first network, the information on whether the UE supports the execution of the MDT measurement of the second network,
receive the information on whether the UE supports the execution of the MDT measurement of the second network, wherein the information on whether the UE supports the execution of the MDT measurement of the second network is transmitted by a network node of the first network, or transmitted by a base station of the second network, or transmitted by a network node of the second network, or forwarded by a network node of the second network through a base station of the second network.

28. The base station according to claim 27, wherein the information on whether the UE supports the execution of the MDT measurement of the second network is comprised in UE context information or UE initial context establishing request information.

29. The base station according to claim 23, wherein the processor is further configured to execute the program to: after receiving, by the base station of the first network, the information on whether the UE supports the execution of the MDT measurement of the second network,
transmit, when the UE is being handed over from the base station of the first network to a target base station, information on whether the UE supports the execution of the MDT measurement of the second net work which corresponds to the UE being handed over, to the target base station.

30. The base station according to claim 23, wherein the processor is further configured to execute the program to:
select, when the UE is located in the area specified by the information about the configuration of the MDT measurement of the second network and supports the execution of the MDT measurement of the second network, the UE to execute the MDT measurement of the second network; and
not select, when the UE is not located in the area specified by the information about the configuration of the MDT measurement of the second net work or does not support the execution of the MDT measurement of the second network, the UE to execute the MDT measurement of the second network.

31. The base station according to claim 23, wherein the base station of the first network and the base station of the second network share the network manager, and the processor is further configured to execute the program to:
receive the information about the configuration of the MDT measurement of the second network directly transmitted by the network manager; or
receive the information about the configuration of the MDT measurement of the second network forwarded by the network manager through the network node of the first network.

32. The base station according to claim 23, wherein the base station of the first network and the base station of the second network correspond to respective independent network managers, and the processor is further configured to execute the program to:
receive the information about the configuration of the MDT measurement of the second network forwarded by the network manager of the second network through the network manager of the first network; or
receive the information about the configuration of the MDT measurement of the second network forwarded by the network manager of the second network through the base station of the second network.
